(19) United States
(12) Patent Application Publication
(10) Pub. No.: US 2008/0022241 A1
(43) Pub. Date: Jan. 24, 2008

(54) Method for the functional verification of at least one analog circuit block

(76) Inventor: Friedrich Hiller, Zuzenhausen (DE)

Correspondence Address: MG-IP Law, PLLC, P.O. BOX 1364, FAIRFAX, VA, 22038-1364, US

(21) Appl. No.: 11/822,307

(22) Filed: Jul. 5, 2007

Related U.S. Application Data
(60) Provisional application No. 60/819,384, filed on Jul. 10, 2006.

(30) Foreign Application Priority Data
Jul. 5, 2006 (DE) DE 102006031027

(51) Int. Cl. G06F 17/50

(52) U.S. Cl. 716/5

(57) ABSTRACT

A method is provided for verifying at least one circuit block or a circuit, which has at least two interconnected circuit blocks, in which for digitalizing the signal values, in a first verification step, at least one line is supplied with the signal at the input of the block, in a second step, the signal at the output of the block is checked for a predefined target function, in a third step, a data value is assigned to the circuit block when the predefined target function is achieved and another data value when the predefined target value is not achieved, and in a fourth step, the assigned data value is stored with an indication of the circuit block supplied with a signal.

This nonprovisional application claims priority to German Patent Application No. DE 102006031027, which was filed in Germany on Jul. 5, 2006, and to U.S. Provisional Application No. 60/819,384, which was filed on Jul. 10, 2006, and which are both herein incorporated by reference.

### BACKGROUND OF THE INVENTION

1. Field of the Invention

The present invention relates to a method for verifying at least one circuit block, and a method verifying at least two interconnected circuit blocks within a circuit.

2. Description of the Background Art

Analog subsystems and circuit blocks provide indispensable functions in integrated circuits and systems. Despite the fact that they make up a small percentage of the total circuit area, compared with a digital circuit part, analog blocks generate a significant portion of the development cost. The designing of analog circuits for use, for example, in the motor vehicle industry requires the inclusion of external components such as sensors and actuators in the development process.

The following abstraction levels can be differentiated in the designing of analog systems: system level, block level, subcircuits, and components.

An analog system represents a circuit block with a specific functionality. The requirements for the analog system result from embedding into the entire mixed-signal system. Analog systems can be on the order of a few hundred to several thousand transistors.

Analog cells or blocks are the building blocks that make up an analog system. An analog block or an analog cell always perceives only one specific function within the analog system, for example, amplification, modulation, etc.; there is a plurality of realizations (topologies) for each function, however. The blocks are described by their circuit properties and typically consist of a manageable number of transistors (normally up to 50 transistors).

Subcircuits, a few transistors in size, are the basic building blocks constituting an analog block, e.g., differential stage or PTAT. At the component level (electrical level/transistor level), the circuit is described by its structural elements and connectivities. There are models for the individual structural elements in the simulator, so that the circuit can be simulated at the electrical level in a circuit simulator.

An analog circuit design at the block level is iterative and consists substantially of three design steps: topology generation, dimensioning of the topology elements, and verification whether the circuit meets the specification. The topologies are created with use of a layouter or selected from a library of already available topologies.

In the dimensioning, the circuit parameters (e.g., lengths and widths of the transistors, capacitance and resistance values) are to be set for the given topology in such a way that the circuit fulfills the requirements imposed on it. In addition, the circuit is to be as robust as possible to changes in the operating environment or variations in the manufacturing process.

The dimensioning in turn can be divided into two steps. First, a nominal design occurs. In this case, the circuit is dimensioned in such a way that it fulfills the requirements imposed on it at the nominal point. The nominal point describes typical values for the operating parameters and a typical manufacturing process. The result of the nominal design should be a dimensioning that offers the best possible starting point for subsequent simulation-intensive design centering.

The dimensioning of a circuit is to be followed by design centering to improve the efficiency.

The goal of design centering is to dimension the circuit in such a way that it is robust to influences of operating parameters and process variations. This at the same time means a high efficiency with consideration of parameter variations.

Current tools, however, normally require a very high investment from the user, which results from time-consuming preparation of data sets and the elaboration of simulation runs. Moreover, with today's circuit design complexity, analyses have a high time and cost factor. Another challenge is local parameter variations, whose effect on circuit behavior becomes increasingly greater with increasingly smaller structures in the submicron range.

A simulation-based method for nominal design and design centering of analog circuit blocks (with 10 to 30 free parameters) at the component level (transistor level) was presented in the dissertation “Dimensioning of analog integrated circuits with consideration of structural constraints” by Robert Schwencker (Technical University of Munich, Dec. 13, 2001). The dimensioning was formulated as a mathematical optimization problem. The evaluation of the target function and the determination of the necessary gradients usually require several circuit simulations (simulator in a loop) and high computing power.

Furthermore, so-called top-down designs are known with whose help a specification is realized at the system level in a circuit. These have been well developed and automated primarily for digital circuits but are not directly portable to analog circuits, because, among other things, a value- and time-continuous analysis is necessary.

Analog designers typically realize a system specification in a circuit by selecting, combining, and then dimensioning known basic topologies based on their experience. The dimensioning is carried out by calculations and iterative simulations of this circuit until it meets the specification. The know-how, to represent an abstract function in a specific circuit topology, accordingly comes from years of experience.

After the design of the analog circuit is completed, it is checked visually on screen using a software tool called a wave viewer.

In so doing, vast amounts of data are generated. For example, in checking an oscillator block within simulation intervals that can last from a few microseconds to several milliseconds, thousands of oscillations with 20 to 50 data values are generated per oscillation.

The following method is also known from “Computer-Aided Design of Analog and Mixed-Signal Integrated Circuits” by Gielen, G., Rutenbar, R., Proc. IEEE, Vol. 88; Dec. 2000 and “Analog Circuit Synthesis” by Jores, P., Analog, 96, Berlin, October 1996. The starting point is a system architecture, which meets the specification at the system level. The system architecture represents a signal flow description, which consists of function blocks, each block containing a system parameter. In order to develop an electrical circuit (conservative) at the system level (nonconservative), first electrical boundary conditions are shown at the system level. To accomplish this, an electrical parameter (current, voltage) is selected and shown as a signal at the system level.

Depending on the definition of the function blocks, the input and output signals of each function block are defined. A signal here represents either current (I) or voltage (U). Each function block can be realized as an I/I, I/U, U/I, or U/U block. These blocks are replaced in the subsequent phase by circuits whose behavior corresponds to the function of the block.

In the interconnection of blocks, impedance matching must still be performed and pin compatibility must be checked. The assignment follows the principle that the behavior of a circuit in a specific operating range represents a mathematical function. The information for the input and output behavior of the topologies selected for the blocks within a specific operating range consists of boundary conditions of the electrical circuit level, such as, e.g., supply voltages and operating point settings that the designer must define.

In the analysis of integrated circuits, however, the problem arises time and again that faults cannot be detected, because the simulation has not covered a certain constellation of circuit parameters. The high complexity of the circuits has the result that only special signals are checked. For reasons of time, the complete simulation of the circuit is limited to the most important constellations. Nevertheless, very high amounts of data arise, which must be managed in the evaluation.

### SUMMARY OF THE INVENTION

It is therefore an object of the present invention to provide a method by which the aforementioned disadvantages in the prior art can be overcome.

Accordingly, the essence of the invention is that in a method for verifying a circuit block, which has input and output lines for electrical signals (I, U), in a first verification step, at least one line is supplied with a signal (I, U) at the input of the block, in a second step, the signal is checked at the output of the block for a predefined target function, in a third step, a data value, particularly “1,” is assigned to the circuit block when the predefined target function is achieved and another data value, particularly “0,” when the predefined target value is not achieved, and in a fourth step, the assigned data value is stored with an indication of the circuit block supplied with a signal.

Compared with a visual check of the circuit block, in which there would be a very large amount of data within a test interval, in the method of the invention, the amount of data is limited to a minimum. The signal values are digitalized by assigning in each case a data value, particularly “1,” when a target function is achieved and another data value, particularly “0,” when it is not achieved.

For example, the method can be used first to test whether a circuit block is functioning at all or not functioning. In the aforementioned case, the target function is defined such that the assignment of the data value “1” is made when a signal can be measured at the output of the circuit block.

In contrast, a precisely defined threshold value can be set as the target function, so that the data value “1” is assigned only when this specific threshold value is achieved, for example, a specific amplitude or a specific frequency in an oscillator. When the defined target value is not achieved, the data value “0” is assigned in each case. Possible circuit blocks in this regard are also, inter alia, operational amplifiers, band gaps, modulators, or oscillators.

In a development of the invention, a method is provided for verifying at least one circuit block within a circuit that has at least two interconnected circuit blocks. In this regard, the circuit blocks have lines for electrical signals (I, U) at the particular inputs and outputs, by means of which the circuit blocks are interconnected. In a first verification step, at least one line is supplied with a signal (I, U) at the input of a circuit block, in a second step, the signal at the output of the circuit block, which is connected to the input of another circuit block, is checked for a predefined target function, in a third step, a data value, particularly “1” is assigned to the circuit block when the predefined target function is achieved and another data value, particularly “0,” when the predefined target value is not achieved, and in a fourth step, the assigned data value is stored with an indication of the circuit block supplied with a signal.

As a result, a structural testing method is provided which can be used to test how an individual circuit block that is coupled to other circuit blocks is working. It can also be determined in this way whether there are technical pitfalls that cannot be detected during the testing of the entire circuit with regard to what the specification requires. There, only the action of the entire circuit is determined without finding out how it is working internally.

The advantages of this structural testing method are that subsequent effects that may occur because of the lack of agreement among designers can be detected. If, for example, the signals at specific blocks have a wrong polarity, connecting errors are made during connection of the blocks, or a wrong level is applied at the block input, the circuit may have the desired specification within the examined range, without these structural faults being detected. The reason for this is that because of the long simulation times, some faults have an effect only very late or are detected only late at the examined terminals.

An embodiment of the invention, furthermore, provides a method for verifying at least two interconnected circuit blocks within a circuit, whereby the circuit blocks have lines for electrical signals (I, U) at the particular inputs and outputs by means of which the circuit blocks are interconnected. In this method, for verification of the circuit blocks, in a verification step, at least one line is supplied with a signal (I, U) at the input of a circuit block, in a second step, the signal at the output of another block is checked for a predefined target function, in a third step, when the predefined target function is achieved, a data value, particularly “1,” is assigned to the circuit blocks supplied with the signal and another data value, particularly “0,” when the predefined target value is not achieved, and in a fourth step, the assigned data value is stored with an indication of the circuit blocks supplied with a signal.

This development provides a structural testing method which can be used to test how the circuit blocks work with mutual action. In this case, several interconnected circuit blocks are activated. It can be determined here whether connection errors were made during connection of the blocks or undesirable coupling effects occur between the blocks.

Another embodiment of the method is to develop test parameters for the signals in the form of intervals with one lower and one upper limit in the aforementioned method for testing the activity control of at least one circuit block as a function of the target function. In a first verification step, at least one line is supplied with a signal (I, U) at the input of a circuit block, in a second step, the signal at the output of a circuit block is checked for the predefined intervals, in a third step, the at least one circuit block is assigned a data value, particularly “1,” when the signal passes the lower limit of the interval, and/or another data value, particularly “0,” when the signal exceeds the upper limit or does not reach the lower limit. Finally, in a fourth step, the assigned data value is stored with an indication of the at least one circuit block supplied with a signal.

By selection of suitable criteria in the form of intervals, which in each case correspond to the required specification of the circuit block or circuit blocks with respect to the upper and lower limit, it can be determined in each case whether the individual circuit block meets the requirements by itself or in combination with the other circuit blocks.

Because of digitalization of the signal values, the volume of data to be evaluated is reduced by a factor of four. As a result, it is again possible to test numerous combinations and constellations within a short time during the interaction of circuit blocks.

According to an aspect of the method, the steps “supplying a line with a signal (I, U) at the input of the circuit block” and “testing of the signal at the output of the circuit block for a predefined target function” are each performed within a predefined time interval. It can be determined in this way whether a circuit block was actually turned on within the predefined simulation time, or whether a specific threshold was achieved, etc.

It is provided furthermore to store and total the data values in a table. This makes it possible to determine at a glance after completion of the verification runs how often a circuit block was connected or turned on overall or how often the signal at the output of the circuit block had exceeded a lower or upper limit. It is possible furthermore to detect immediately how often the target function was not achieved or was exceeded within a predefined time interval.

In an emgodiment of the invention, it is provided to create a table in which the data values and/or totals of the data values for all circuit blocks of the circuit are stored. This produces, on the one hand, a summary of all circuit blocks independent of their hierarchy and, on the other, an overview or test coverage of the entire circuit. After completion of the aforementioned table, it can be seen at a glance how often a specific block was active or inactive within the circuit, whether and how often a specific target function was achieved, or how often a lower or upper limit of a required specification was exceeded.

It is especially advantageous for testing the activity control of each individual circuit block with respect to the time point of the signal state to store a time value in addition to each data value. This makes it possible to detect when the circuit block had achieved or exceeded a target function within the test interval.

By presetting expected values with respect to the time point, the correct function can be tested directly in individual blocks and in the case of faults a report can be generated that specifies the fault location. This greatly simplifies the search for faults.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically an analog circuit block.

FIG. 2 shows schematically a circuit with several analog circuit blocks.

FIG. 3 shows a first oscillation curve at the output of an oscillator as an example of an analog circuit block over a time interval T1.

FIG. 4 shows a curve of the assigned data values “0” and “1” over time interval T1.

FIG. 5 shows an oscillation curve at the output of a voltage regulator over a time interval T2.

FIG. 6 shows a curve of the assigned data values “0” and “1” over time interval T2.

FIG. 7 shows a second oscillation curve at the output of a voltage regulator over a time interval T3.

FIG. 8 shows a curve of the assigned data values “0” and “1” over time interval T3.

FIG. 9 shows a table with the stored and totaled data values of the oscillation curve from FIG. 7.

FIG. 10 shows another oscillation curve at the output of an oscillator over a time interval T4.

FIG. 11 shows a curve of the frequencies over time interval T4.

FIG. 12 shows a curve of the assigned data values “0” and “1” over time interval T4.

### DETAILED DESCRIPTION

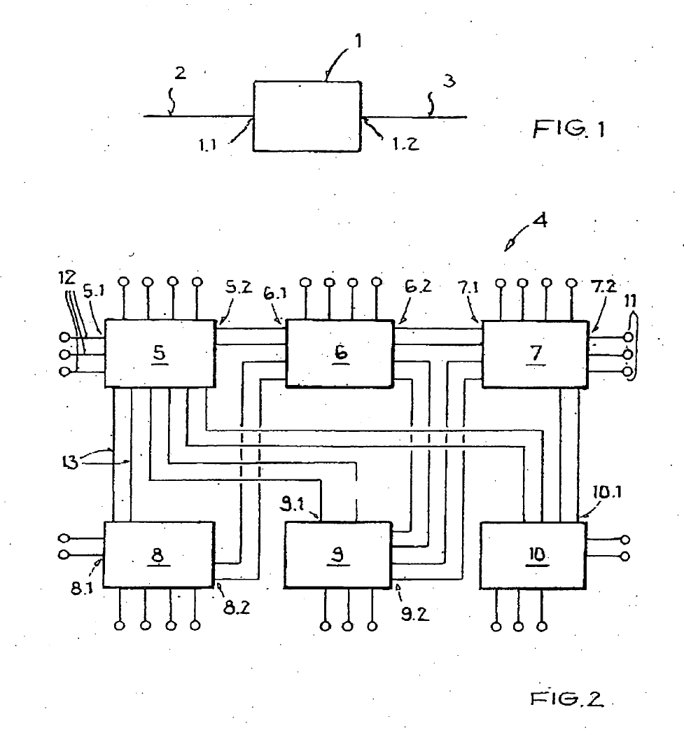

FIG. 1 shows schematically an analog circuit block 1. This can concern components such as an oscillator, a band gap, a modulator, a demodulator, or a phase-locked loop. Circuit block 1 has at least one input 1.1 and at least one output 1.2. A line 2 leads to input 1.1 and a line 3 leads away from output 1.2, each of which can be supplied with a temporary signal (I, U).

FIG. 2 shows schematically a circuit 4 with several analog circuit blocks 5-10. Each circuit block 5-10 has at least one input 5.1-10.1 and at least one output 5.2-10.2. Furthermore, circuit 4 has lines 12, which connect circuit 4 to contact areas 11 via one of the circuit blocks 5-10. It is possible to apply signals from outside to lines 12 via contact areas 11. Lines 13 are used to interconnect circuit blocks 5-10 and each of these connect the output of a circuit block 5.2-10.2 to an input of another circuit block 5.1-10.1.

FIG. 3 shows a first oscillation curve at the output of an oscillator as an example of an analog circuit block over a time interval T1.

During time interval T1, it is tested whether the oscillator begins to oscillate at all after it was activated from outside. The oscillation curve shows that an oscillation has begun after 10 ms. After 30 ms, the oscillation was interrupted and the oscillation began again after 35 ms. No oscillation was measured within the time intervals from 0 to 10 ms and from 30 to 35 ms at the output of the oscillator.

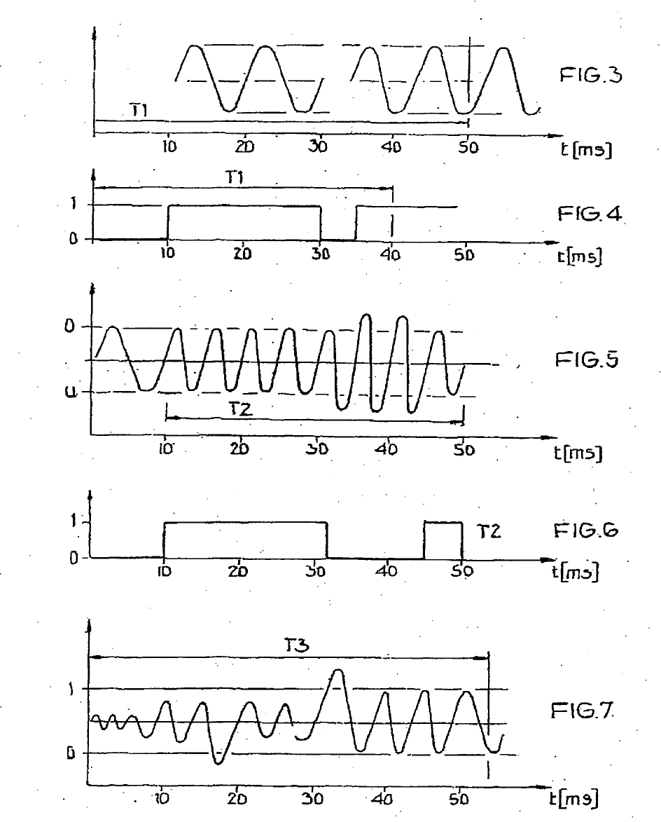

FIG. 4 accordingly shows a curve of the assigned data values “0” and “1” over time interval T1. As long as no signal is measured at the output of the oscillator, this signal is assigned the data value “0.” After 10 ms, the defined target function, namely, the occurrence of a signal, is achieved and the signal value is assigned the data value “1.”

FIGS. 5 and FIG. 7 also show a signal course at the output of a voltage regulator over a time interval T2 or T3. The intent of this verification run is to test whether the voltages are within a specific amplitude range during a predefined time interval. An interval with an upper limit O and a lower limit U is defined for the predefined amplitude range.

FIG. 6 and FIG. 8 each show the curve of the assigned data values “0” and “1” over the time interval T2 and T3. As long as the voltage values lie within the defined interval, the signal is assigned a data value “1.” If the signal falls below the lower limit U or the signal exceeds the upper interval limit O, a data value “0” is assigned. In the evaluation of the data values, it can therefore be seen at a glance that the voltages at the voltage regulator have left the defined range several times.

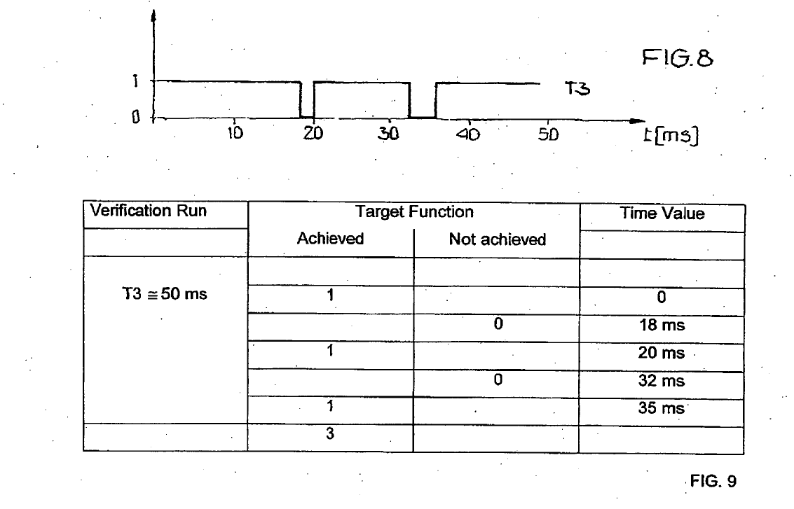

FIG. 9 shows a table with the stored and totaled data values of the signal curve from FIG. 7. The graphic curve of the data values is converted to a numerical form with use of the table. A data value “0” or “1” is added each time when a change in the signal curve occurs such that the upper or lower limit of the target function, therefore a specified interval, has been exceeded or underrun, respectively. It is immediately evident from the totals of the data values how often an unwanted change in the signal curve has occurred during a test interval. The total of the data values is then transferred to another table for all tested circuit blocks or for all tested outputs of the circuit blocks. The final table then provides an overview of the test coverage of the entire circuit.

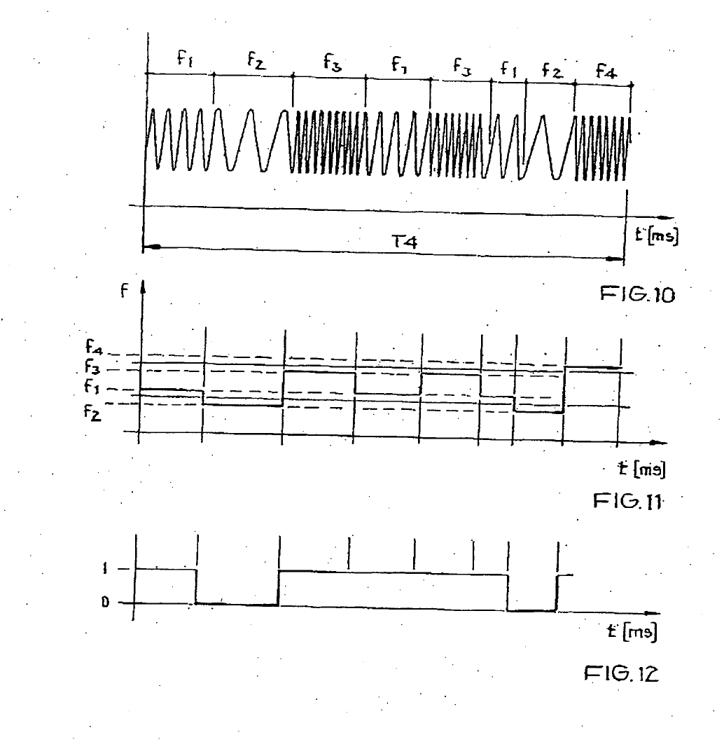

FIG. 10 shows another oscillation curve at the output of an oscillator over a time interval T4. The intent of this verification run is to test whether the oscillations are within a specific frequency range during a predefined time interval.

FIG. 11 shows the associated curve of the frequencies from FIG. 10 over time interval T4. For the predefined frequency range, an interval with an upper limit O and a lower limit U is defined. This concerns an intermediate step.

FIG. 12 accordingly shows the curve of the assigned data values “0” and “1” over time interval T4. As long as the frequency values lie within the defined interval, the signal is assigned the data value “1.” If the signal falls below the lower limit U or the signal exceeds the upper interval limit O, a data value “0” is assigned. Here as well, it is possible to detect immediately when the oscillator has operated within the target range.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for verifying at least one circuit block, the method comprising:
providing at least one line for the circuit block for an electrical signal at an input and output of the circuit block,
supplying, in a first verification step, at least one line with a signal at the input of the circuit block;
checking the signal at the output of the circuit block for a predefined target function;
assigning, when the predefined target function is achieved, a first data value, to the circuit block and a second data value when the predefined target value is not achieved; and
storing the assigned data value with an indication that the circuit block is supplied with a signal.

2. A method for verifying at least one circuit block within a circuit, which has at least two interconnected circuit blocks, the method comprising:
providing lines for the circuit blocks for electrical signals, at the particular inputs and outputs;
interconnecting the circuit blocks via the lines;
supplying at least one line with a signal at the input of a circuit block;
checking the signal at the output of the circuit block, which is connected to the input of another circuit block, for a predefined target function;
assigning a first data value to the circuit block when the predefined target function is achieved and a second data value when the predefined target value is not achieved; and
storing the assigned data value with an indication that the circuit block is supplied with a signal.

3. A method for verifying at least two interconnected circuit blocks within a circuit, the method comprising:
providing lines for the circuit blocks for electrical signals at inputs and outputs of the circuit block;
interconnecting the circuit blocks via the lines;
supplying, in a first verification step, at least one line with a signal at the input of a circuit block;
checking the signal at the output of another block is checked for a predefined target function;
assigning a first data value to the circuit blocks with the signal when the predefined target function is achieved and a second data value when the predefined target value is not achieved; and
storing the assigned data value with an indication that the circuit blocks is supplied with a signal.

4. The method according to claim 1, wherein test parameters are created for the signals in the form of intervals with one lower and one upper limit for testing the activity control of at least one circuit block as a function of the target function, so that in a first verification step, at least one line is supplied with a signal at the input of a circuit block, wherein the signal at the output of a circuit block is checked for the predefined intervals, wherein the at least one circuit block is assigned the first data value when the signal exceeds the lower limit of the interval and is assigned the second data value when the signal exceeds the upper limit or does not reach the lower limit, and wherein the assigned first or second data value is stored with an indication that the at least one circuit block is supplied with a signal.

5. The method according to claim 1, wherein the steps of supplying the at least one line with a signal and the step of checking the signal at the output of the circuit block are each performed within a predefined time interval.

6. The method according to claim 1, wherein the first and second data values are stored and totaled in a table.

7. The Method according to claim 6, wherein the totals of the first or second data values for the circuit block or circuit blocks supplied with a signal are stored in another table.

8. The method according to claim 1, wherein, for testing the activity control of each individual circuit block with respect to a time point of the signal state, a time value is stored for each data value.

9. The method according to claim 1, wherein the first data value is a 1 and the second data value is a 0.

10. The method according to claim 2, wherein the first data value is a 1 and the second data value is a 0.

11. The method according to claim 3, wherein the first data value is a 1 and the second data value is a 0.
